(19) United States
(12) Patent Application Publication
(10) Pub. No.: US 2019/0377220 A1
(43) Pub. Date: Dec. 12, 2019

(54) LIQUID CRYSTAL PANEL AND LIQUID CRYSTAL DISPLAY DEVICE

(71) Applicant: Sharp Kabushiki Kaisha, Sakai City (JP)

(72) Inventor: Yoshinori OHHITSU, Sakai City (JP)

(21) Appl. No.: 15/929,137

(22) Filed: Jun. 5, 2019

Related U.S. Application Data
(60) Provisional application No. 62/683,110, filed on Jun. 11, 2018.

(51) Int. Cl. G02F 1/1335; G02F 1/1362

(52) U.S. Cl. CPC G02F 1/133512; G02F 1/1368; G02F 2201/56; G02F 1/136286

(57) ABSTRACT

A liquid crystal panel is capable of being curved such that a first end and a second end come close to each other with respect to a standard axis. In a non-curved state of the liquid crystal panel, a first central axis halving a width of a black matrix and a second central axis halving a width of a conductive line satisfy a relation of: (A) between the first end and the standard axis, the first central axis is shifted closer to the first end, and between the second end and the standard axis, the first central axis is shifted closer to the second end, or (B) between the first end and the standard axis, the first central axis is shifted closer to the standard axis, and between the second end and the standard axis, the first central axis is shifted closer to the standard axis.

### CROSS-REFERENCE TO RELATED APPLICATIONS

The present application claims priority under 35 U.S.C. § 119 to U.S. Provisional Patent Application No. 62/683,110 filed on Jun. 11, 2018, the contents of which are incorporated herein by reference in their entirety.

### BACKGROUND OF THE INVENTION

### Field of the Invention

The present invention relates to liquid crystal panels and liquid crystal display devices.

### Description of Related Art

In a recent trend where liquid crystal display devices are used in various applications, a technique for curving a liquid crystal panel, which is a component of a liquid crystal display device, has been studied (e.g., JP 2008-145778 A).

### BRIEF SUMMARY OF THE INVENTION

Unfortunately, the present inventor found through studies that curving a liquid crystal panel in a liquid crystal display device deteriorates the display quality. The causes of this are described in the following.

FIG. 12 is a schematic cross-sectional view showing a non-curved state of a conventional liquid crystal panel. As shown in FIG. 12, a liquid crystal panel 102 includes, in the following order from the viewing surface side to the back surface side, a color filter substrate 110, a liquid crystal layer 120, and a thin-film transistor array substrate 130.

The color filter substrate 110 includes a supporting substrate 111, a black matrix 112, and color filters 113. The black matrix 112 and the color filters 113 are disposed on the liquid crystal layer 120 side surface of the supporting substrate 111.

The thin-film transistor array substrate 130 includes a supporting substrate 131, conductive lines 132, and pixel electrodes 133. The conductive lines 132 and the pixel electrodes 133 are disposed on the liquid crystal layer 120 side surface of the supporting substrate 131.

In a non-curved state of the liquid crystal panel 102, as shown in FIG. 12, when light is applied with a backlight from the back surface side of the liquid crystal panel 102, emitted beams M1 from the backlight pass through aperture regions where the respective color filters 113 and pixel electrodes 133 are superimposed with each other. The emitted beams are then recognized as display light (an image provided by the liquid crystal panel 102). Meanwhile, the region with the black matrix 112, which partitions the aperture regions through which the emitted beams M1 from the backlight pass, encompasses the regions with the conductive lines 132 (conductive lines 132 are hidden on the back surface side of the black matrix 112) and thereby blocks emitted beams M2 from the backlight.

FIG. 13 is a schematic plan view of the liquid crystal panel shown in FIG. 12, which is in a curved state and is observed from the thin-film transistor array substrate side. FIG. 14 is a schematic cross-sectional view taken along the line G-G′ of the liquid crystal panel shown in FIG. 13. In a curved state of the liquid crystal panel 102, as shown in FIGS. 13 and 14, the black matrix 112 and the conductive lines 132 are misaligned, namely, the regions with the conductive lines 132 are not superimposed with the region with the black matrix 112. Thereby, as shown in FIG. 14, the emitted beams M2 from the backlight, which should be blocked by the black matrix 112, unfortunately pass through the color filters 113 (aperture regions). As a result, when focused on the region with a pixel electrode 133, emitted beams M2 from the backlight, which should not be recognized, are recognized as light leakage in addition to emitted beams M1 from the backlight, which should be recognized as display light. Such a state also causes color mixture when the color filters 113 disposed on adjacent aperture regions have different colors.

In response to this issue, JP 2008-145778 A discloses that such light leakage can be prevented by enlarging the width of the black matrix. The present inventor found through studies that, unfortunately, simply enlarging the width of the black matrix as in JP 2008-145778 A significantly reduces the aperture ratio and that there is still room for improvement in achieving excellent display quality.

The present invention has been made under the current situation in the art and aims to provide a liquid crystal panel that can achieve excellent display quality even in a curved state, and a liquid crystal display device including the liquid crystal panel.

The present inventor made various studies on a liquid crystal panel that can achieve excellent display quality even in a curved state to find that enlarging the width of the black matrix in consideration of the direction the position of the black matrix is shifted when curving a liquid crystal panel achieves suppression of a reduction in aperture ratio and prevention of light leakage. The inventor thereby successfully found a measure to the issue to arrive at the present invention.

(1) An embodiment of the present invention is a liquid crystal panel including: a color filter substrate including a black matrix; a thin-film transistor array substrate including a conductive line; and a liquid crystal layer held between the color filter substrate and the thin-film transistor array substrate, the liquid crystal panel being capable of being curved such that a first end and a second end facing the first end come close to each other with respect to a standard axis extending in a first direction, in a non-curved state of the liquid crystal panel, a region with the black matrix encompassing a region with the conductive line in a second direction that is perpendicular to the first direction, and in the non-curved state of the liquid crystal panel, in the second direction, a first central axis at a position halving a width of the black matrix and a second central axis at a position halving a width of the conductive line satisfying a relation of: (A) in a first end region between the first end and the standard axis, the first central axis is shifted closer to the first end than the second central axis is, and in a second end region between the second end and the standard axis, the first central axis is shifted closer to the second end than the second central axis is, or (B) in the first end region between the first end and the standard axis, the first central axis is shifted closer to the standard axis than the second central axis is, and in the second end region between the second end and the standard axis, the first central axis is shifted closer to the standard axis than the second central axis is.

(2) An example of the embodiment of the present invention is the liquid crystal panel according to the above item (1), wherein the standard axis is located at a position halving a width of the liquid crystal panel in the second direction.

(3) Another example of the embodiment of the present invention is the liquid crystal panel according to the above item (1) or (2), wherein the black matrix has a constant width in the second direction in a plane of the liquid crystal panel.

(4) Another embodiment of the present invention is a liquid crystal display device including the liquid crystal panel according to any one of the above item (1) to (3) and a backlight.

The present invention can provide a liquid crystal panel that can achieve excellent display quality even in a curved state and a liquid crystal display device including the liquid crystal panel.

### BRIEF DESCRIPTION OF THE DRAWINGS

FIG. 1 is a schematic perspective view showing a non-curved state of a liquid crystal panel in a liquid crystal display device of Embodiment 1.

FIG. 2 is a schematic plan view of the liquid crystal panel shown in FIG. 1 observed from the thin-film transistor array substrate side.

FIG. 3 is a schematic cross-sectional view taken along the line A-A′ of the liquid crystal panel shown in FIGS. 1 and 2.

FIG. 4 is a schematic perspective view showing a curved state of the liquid crystal panel shown in FIG. 1.

FIG. 5 is a schematic plan view of the liquid crystal panel shown in FIG. 4 observed from the thin-film transistor array substrate side.

FIG. 6 is a schematic cross-sectional view taken along the line A-A′ of the liquid crystal panel shown in FIGS. 4 and 5.

FIG. 7 is a schematic cross-sectional view showing a non-curved state of a liquid crystal panel of Embodiment 2.

FIG. 8 is a schematic perspective view showing a curved state of the liquid crystal panel shown in FIG. 7.

FIG. 9 is a schematic cross-sectional view taken along the line A-A′ of the liquid crystal panel shown in FIG. 8.

FIG. 10 is a graph showing the amount of misalignment of the color filter substrate with respect to the thin-film transistor array substrate in a liquid crystal panel in a curved state.

FIG. 11 is a graph showing the luminances of a liquid crystal display device in a curved state and in a non-curved state of a liquid crystal panel.

FIG. 12 is a schematic cross-sectional view showing a non-curved state of a conventional liquid crystal panel.

FIG. 13 is a schematic plan view of the liquid crystal panel shown in FIG. 12, which is in a curved state and is observed from the thin-film transistor array substrate side.

FIG. 14 is a schematic cross-sectional view taken along the line G-G′ of the liquid crystal panel shown in FIG. 13.

### DETAILED DESCRIPTION OF THE INVENTION

The present invention is described below in more detail based on embodiments with reference to the drawings. The embodiments, however, are not intended to limit the scope of the present invention. The configurations employed in the embodiments may appropriately be combined or modified within the spirit of the present invention.

The expression “X to Y” as used herein means “X or more and Y or less”.

### Embodiment 1

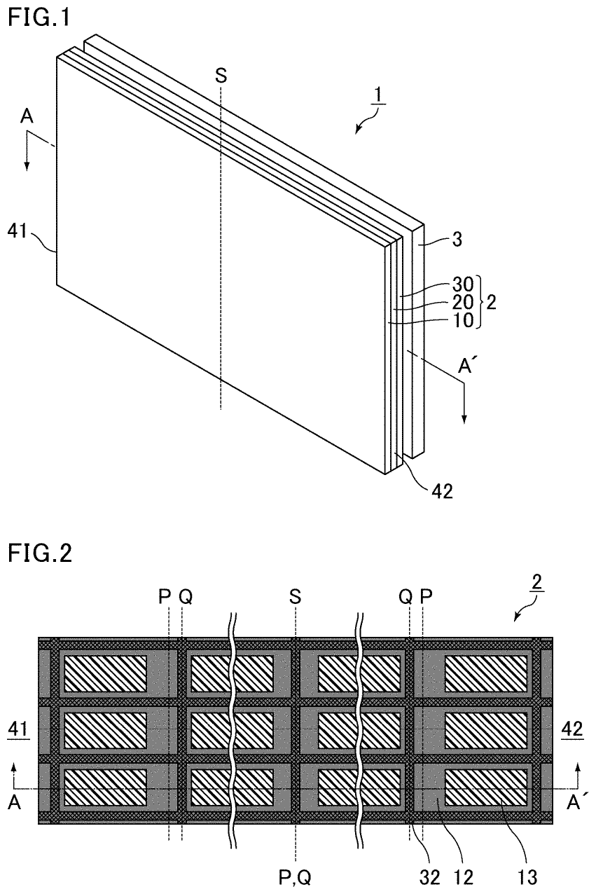

FIG. 1 is a schematic perspective view showing a non-curved state of a liquid crystal panel in a liquid crystal display device of Embodiment 1. As shown in FIG. 1, a liquid crystal display device 1 includes, in the following order from the viewing surface side to the back surface side, a liquid crystal panel 2 and a backlight 3.

The “viewing surface side” as used herein means a side closer to the screen (display surface) of a liquid crystal display device and is, for example, a side closer to the viewer of the drawing (liquid crystal panel 2 side) of the liquid crystal display device 1 shown in FIG. 1. The “back surface side” as used herein means a side remote from the screen (display surface) of a liquid crystal display device and is, for example, a side remote from the viewer of the drawing (backlight 3 side) of the liquid crystal display device 1 shown in FIG. 1.

### <Backlight>

The backlight 3 may be a conventionally known backlight. The backlight 3 may be, for example, an edge-lit backlight or a direct-lit backlight. Examples of the light source of the backlight 3 include light emitting diodes (LEDs) and cold cathode fluorescent lamps (CCFLs).

### <Liquid Crystal Panel>

The liquid crystal panel 2 includes, in the following order from the viewing surface side to the back surface side, a color filter substrate 10, a liquid crystal layer 20, and a thin-film transistor array substrate 30. The liquid crystal panel 2 is capable of being curved such that, for example, with respect to a standard axis S extending in the short direction, a longitudinal end 41 and the other longitudinal end 42 facing the end 41 come close to each other. The following is an example in which the standard axis S is located at a position (hereinafter, also referred to as “panel center”) halving the width of the liquid crystal panel 2 in the longitudinal direction.

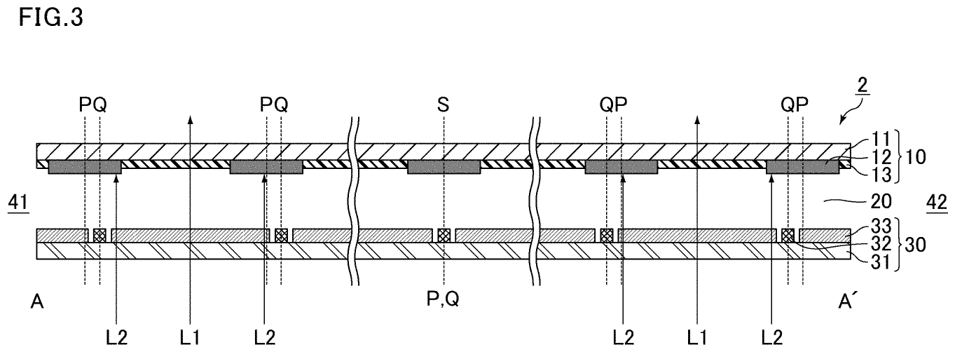

FIG. 2 is a schematic plan view of the liquid crystal panel shown in FIG. 1 observed from the thin-film transistor array substrate side. FIG. 3 is a schematic cross-sectional view taken along the line A-A′ of the liquid crystal panel shown in FIGS. 1 and 2. Here, the direction the line A-A′ extends is perpendicular to the direction the standard axis S extends, namely, is perpendicular to the short direction of the liquid crystal panel 2 and thus corresponds to the longitudinal direction of the liquid crystal panel 2.

The color filter substrate 10 includes a supporting substrate 11, a black matrix 12, and color filters 13. The black matrix 12 and the color filters 13 are disposed on the liquid crystal layer 20 side surface of the supporting substrate 11. The black matrix 12 is disposed such that it partitions the color filters 13.

Examples of the supporting substrate 11 include transparent substrates such as a glass substrate and a plastic substrate.

Examples of the material for the black matrix 12 and the color filters 13 include resins including pigments (color resists). A single-color filter (e.g., red, green, blue) may be disposed in each of aperture regions where the respective color filters 13 and later describing pixel electrodes 33 are superimposed with each other.

The liquid crystal material contained in the liquid crystal layer 20 may be a positive liquid crystal material having positive anisotropy of dielectric constant or a negative liquid crystal material having negative anisotropy of dielectric constant.

The thin-film transistor array substrate 30 includes a supporting substrate 31, conductive lines 32, and pixel electrodes 33. The conductive lines 32 and the pixel electrodes 33 are disposed on the liquid crystal layer 20 side surface of the supporting substrate 31.

Examples of the supporting substrate 31 include transparent substrates such as a glass substrate and a plastic substrate.

Examples of the conductive lines 32 include conductive lines such as gate bus lines and source bus lines. Examples of the material for the conductive lines 32 include metal materials such as aluminum, copper, titanium, molybdenum, and chromium.

Examples of the material for the pixel electrodes 33 include transparent conductive materials such as indium tin oxide (ITO) and indium zinc oxide (IZO).

In the liquid crystal panel 2 in a non-curved state, an axis located at a position halving the width of the black matrix 12 in the longitudinal direction of the liquid crystal panel 2 (hereinafter, simply referred to as “width of the black matrix 12”) is defined as a central axis P, and an axis located at a position halving the width of one conductive line 32 in the longitudinal direction of the liquid crystal panel 2 is defined as a central axis Q. Here, the width of the black matrix 12 corresponds to a distance between adjacent aperture regions in the longitudinal direction of the liquid crystal panel 2. The width of the conductive line 32 corresponds to a width of one conductive line between adjacent aperture regions in the longitudinal direction of the liquid crystal panel 2.

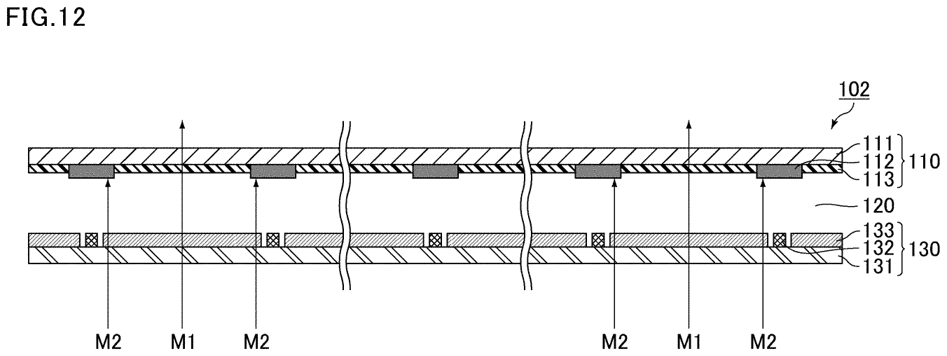

In the above definition, in the end 41 region between the end 41 and the panel center, the central axis P is shifted closer to the end 41 than the central axis Q is. In other words, in the end 41 region between the end 41 and the panel center, the width of the black matrix 12 is enlarged only on the end 41 side, as compared with the width of the black matrix 112 of the conventional liquid crystal panel 102 shown in FIG. 12. In the end 42 region between the end 42 and the panel center, the central axis P is shifted closer to the end 42 than the central axis Q is. In other words, in the end 42 region between the end 42 and the panel center, the width of the black matrix 12 is enlarged only on the end 42 side, as compared with the width of the black matrix 112 of the conventional liquid crystal panel 102 shown in FIG. 12. Here, when part of the black matrix 12 and one of the conductive lines 32 are located at the panel center, the corresponding central axes P and Q may exactly align with the standard axis S as shown in FIGS. 2 and 3 or may be shifted from the standard axis S.

In the liquid crystal panel 2 in a non-curved state, in the longitudinal direction of the liquid crystal panel 2, the region with the black matrix 12 encompasses the regions with the conductive lines 32, namely, the conductive lines 32 are hidden on the back surface side of the black matrix 12. In this state, when light is applied with the backlight 3 from the back surface side of the liquid crystal panel 2, as shown in FIG. 3, emitted beams L1 from the backlight 3 pass through the aperture regions where the respective color filters 13 and pixel electrodes 33 are superimposed with each other. The emitted beams L1 are then recognized as display light (an image provided by the liquid crystal panel 2). Meanwhile, the region with the black matrix 12, which partitions the aperture regions through which the emitted beams L1 from the backlight 3 pass, encompasses the regions with the conductive lines 32 (conductive lines 32 are hidden on the back surface side of the black matrix 12) and thereby blocks emitted beams L2 from the backlight 3.

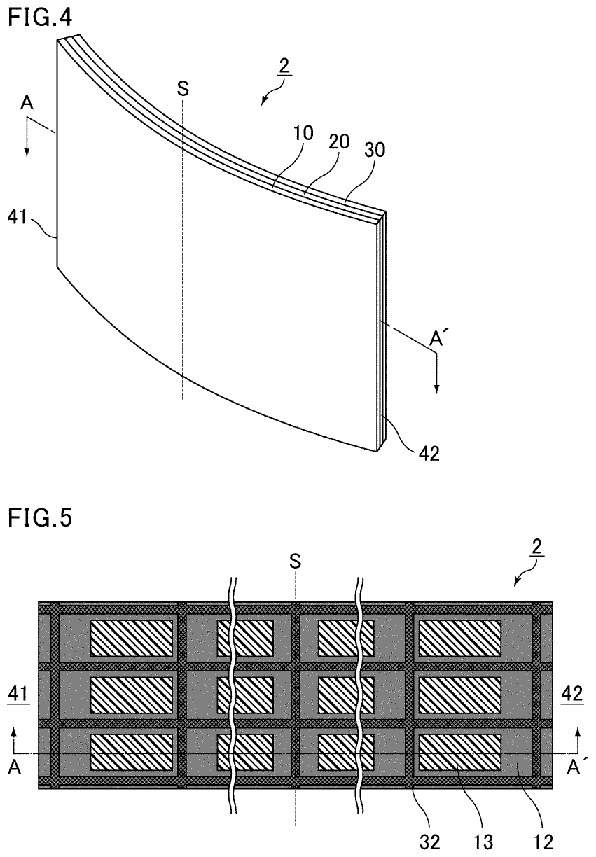

FIG. 4 is a schematic perspective view showing a curved state of the liquid crystal panel shown in FIG. 1. As shown in FIG. 4, when the liquid crystal panel 2 is curved such that the color filter substrate 10 has a convex surface on the viewing surface side, the ends 41 and 42 come close to each other with respect to the standard axis S on the thin-film transistor array substrate 30 side (back surface side).

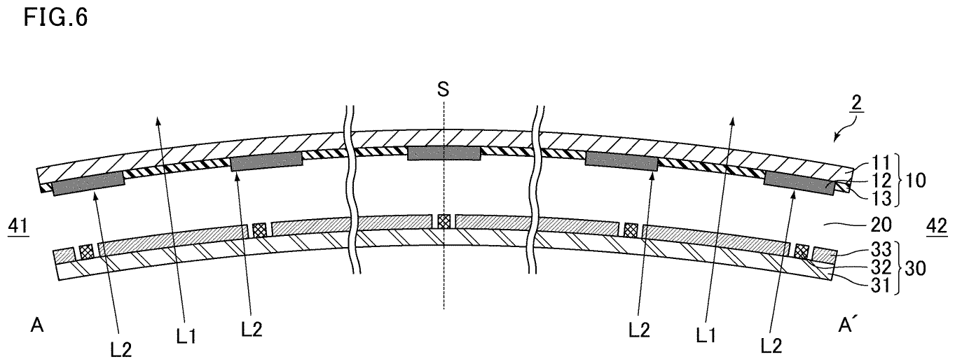

FIG. 5 is a schematic plan view of the liquid crystal panel shown in FIG. 4 observed from the thin-film transistor array substrate side. FIG. 6 is a schematic cross-sectional view taken along the line A-A′ of the liquid crystal panel shown in FIGS. 4 and 5. As shown in FIGS. 5 and 6, in the end 41 region between the end 41 and the panel center of the liquid crystal panel 2 in a curved state, the position of the black matrix 12 is shifted with respect to the conductive lines 32 to the panel center. Here, in the end 41 region between the end 41 and the panel center, the width of the black matrix 12 is enlarged on the end 41 side, whereby, even in the curved state of the liquid crystal panel 2, the regions with the conductive lines 32 are kept encompassed by the region with the black matrix 12 (the conductive lines 32 are kept hidden on the back surface side of the black matrix 12). As a result, even in the curved state of the liquid crystal panel 2 (FIG. 6), the emitted beams L1 from the backlight 3 pass through the aperture regions and the emitted beams L2 from the backlight 3 are blocked by the black matrix 12 as in the non-curved state (FIG. 3).

As shown in FIGS. 5 and 6, in the end 42 region between the end 42 and the panel center of the liquid crystal panel 2 in the curved state, the position of the black matrix 12 is shifted with respect to the conductive lines 32 to the panel center. Here, in the end 42 region between the end 42 and the panel center, the width of the black matrix 12 is enlarged on the end 42 side, whereby, even in the curved state of the liquid crystal panel 2, the regions with the conductive lines 32 are kept encompassed by the region with the black matrix 12 (the conductive lines 32 are kept hidden on the back surface side of the black matrix 12). As a result, even in the curved state of the liquid crystal panel 2 (FIG. 6), the emitted beams L1 from the backlight 3 pass through the aperture regions and the emitted beams L2 from the backlight 3 are blocked by the black matrix 12 as in the non-curved state (FIG. 3).

As described, conventional light leakage can be prevented even in a curved state of the liquid crystal panel 2. Thus, color mixture is also prevented when the color filters 13 have different colors in adjacent aperture regions. In addition, the width of the black matrix 12 is enlarged in consideration of the direction the black matrix 12 is shifted when curving the liquid crystal panel 2. This structure achieves the minimum reduction in aperture ratio. The liquid crystal panel 2 thus can achieve excellent display quality even in a curved state.

In order to provide a liquid crystal panel 2 that can achieve excellent display quality even in a curved state, in the liquid crystal panel 2 in a non-curved state, the amount of misalignment between the central axis P and the central axis Q in the longitudinal direction of the liquid crystal panel 2 is preferably 1 to 12 μm although it depends on the conditions such as the specifications (e.g., size, thickness) of the liquid crystal panel 2 and the curvature radius when curving the liquid crystal panel 2.

In a curved state of the liquid crystal panel 2, the position of the black matrix 12 is hardly shifted with respect to the corresponding conductive line 32 at the panel center. Thus, the width of the black matrix 12 at the panel center may or may not be enlarged. In the state shown in FIG. 3, the width of the black matrix 12 at the panel center is enlarged equally to the end 41 and to the 42 end side as compared with the width of the black matrix 112 of the conventional liquid crystal panel 102 shown in FIG. 12, such that the central axes P and Q exactly align with the standard axis S (panel center). As a result, the black matrix 12 has a constant width in a plane of the liquid crystal panel 2, that is, the evenness of the aperture ratio distribution is constant (aperture ratio is constant in the plane of the liquid crystal panel 2), which contributes to the improvement in the display quality.

### Embodiment 2

Embodiment 2 is the same as the Embodiment 1 except for the region with the black matrix of the liquid crystal panel, and thus the description of the same respects is omitted here.

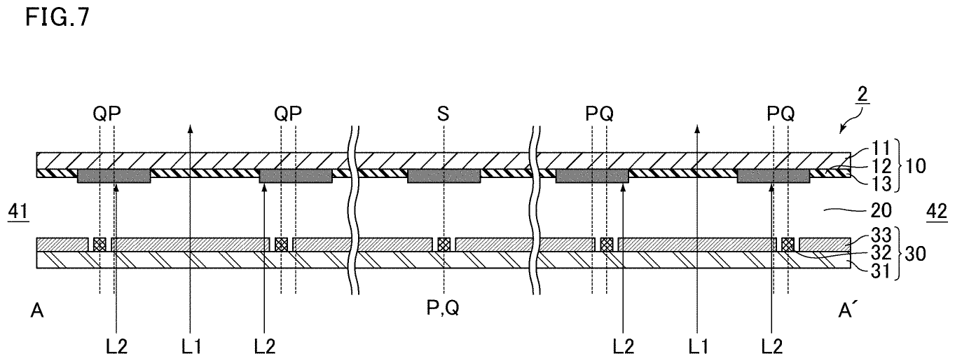

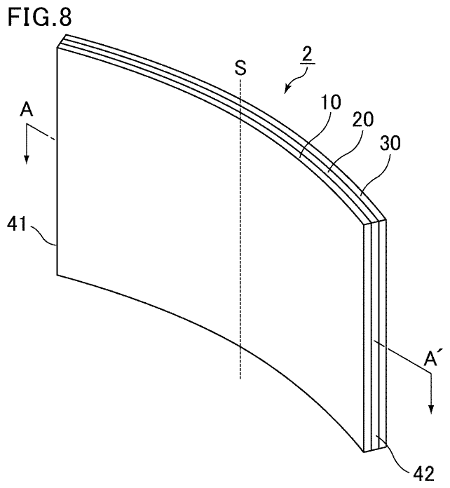

FIG. 7 is a schematic cross-sectional view showing a non-curved state of a liquid crystal panel of Embodiment 2. As shown in FIG. 7, in the end 41 region between the end 41 and the panel center in the liquid crystal panel 2 in a non-curved state, the central axis P is shifted closer to the panel center than the central axis Q is. In other words, in the end 41 region between the end 41 and the panel center, the width of the black matrix 12 is enlarged only on the panel center side, as compared with the width of the black matrix 112 of the conventional liquid crystal panel 102 shown in FIG. 12. In the end 42 region between the end 42 and the panel center, the central axis P is shifted closer to the panel center than the central axis Q is. In other words, in the end 42 region between the end 42 and the panel center, the width of the black matrix 12 is enlarged only on the panel center side, as compared with the width of the black matrix 112 of the conventional liquid crystal panel 102 shown in FIG. 12.

In a non-curved state of the liquid crystal panel 2, the region with the black matrix 12 encompasses the regions with the conductive lines 32 in the longitudinal direction of the liquid crystal panel 2, whereby the conductive lines 32 are hidden on the back surface side of the black matrix 12. In this state, when light is applied with the backlight 3 from the back surface side of the liquid crystal panel 2, as shown in FIG. 7, the emitted beams L1 from the backlight 3 pass through the aperture regions where the respective color filters 13 and pixel electrodes 33 are superimposed with each other. The emitted beams L1 are then recognized as display light (an image provided by the liquid crystal panel 2). Meanwhile, the region with the black matrix 12, which partitions the aperture regions through which the emitted beams L1 from the backlight 3 pass, encompasses the regions with the conductive lines 32 (the conductive lines 32 are hidden on the back surface side of the black matrix 12) and thereby blocks the emitted beams L2 from the backlight 3.

FIG. 8 is a schematic perspective view showing a curved state of the liquid crystal panel shown in FIG. 7. As shown in FIG. 8, when the liquid crystal panel 2 is curved such that the color filter substrate 10 has a concave surface on the viewing surface side, the ends 41 and 42 come close to each other with respect to the standard axis S on the color filter substrate 10 side (viewing surface side).

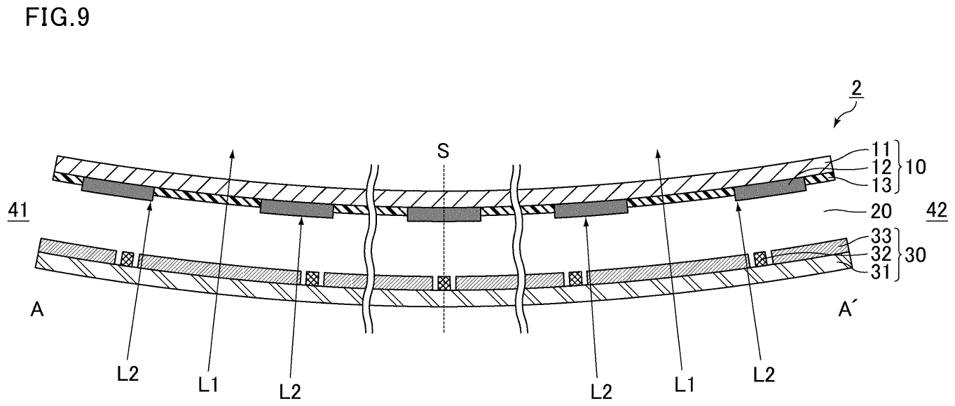

FIG. 9 is a schematic cross-sectional view taken along the line A-A′ of the liquid crystal panel shown in FIG. 8. As shown in FIG. 9, in the end 41 region between the end 41 and the panel center in the liquid crystal panel 2 in a curved state, the position of the black matrix 12 is shifted with respect to the conductive lines 32 to the end 41. Here, in the end 41 region between the end 41 and the panel center, the width of the black matrix 12 is enlarged on the panel center side. Thus, even in the curved state of the liquid crystal panel 2, the regions with the conductive lines 32 are kept encompassed by the region with the black matrix 12 (the conductive lines 32 are kept hidden on the back surface side of the black matrix 12). As a result, even in the curved state of the liquid crystal panel 2 (FIG. 9), the emitted beams L1 from the backlight 3 pass through the aperture regions and the emitted beams L2 from the backlight 3 are blocked by the black matrix 12 as in the non-curved state (FIG. 7).

In the end 42 region between the end 42 and the panel center in the liquid crystal panel 2 in the curved state, as shown in FIG. 9, the position of the black matrix 12 is shifted with respect to the conductive lines 32 to the end 42. Here, in the end 42 region between the end 42 and the panel center, the width of the black matrix 12 is enlarged on the panel center side. Thus, even in the curved state of the liquid crystal panel 2, the regions with the conductive lines 32 are kept encompassed by the region with the black matrix 12 (the conductive lines 32 are kept hidden on the back surface side of the black matrix 12). As a result, even in the curved state of the liquid crystal panel 2 (FIG. 9), the emitted beams L1 from the backlight 3 pass through the aperture regions and the emitted beams L2 from the backlight 3 are blocked by the black matrix 12 as in the non-curved state (FIG. 7).

As described, conventional light leakage can be prevented even in a curved state of the liquid crystal panel 2. Thus, color mixture is also prevented when the color filters 13 have different colors in adjacent aperture regions. In addition, the width of the black matrix 12 is enlarged in consideration of the direction the black matrix 12 is shifted when curving the liquid crystal panel 2. This structure achieves the minimum reduction in aperture ratio. The liquid crystal panel 2 thus can achieve excellent display quality even in a curved state.

Although, in Embodiments 1 and 2, the standard axis S is located at the panel center when curving the liquid crystal panel 2, the standard axis S may not be located at the panel center. In other words, the liquid crystal panel 2 does not have to be symmetrically curved with respect to the panel center, namely, may be unsymmetrically curved with a standard axis located at a position shifted from the panel center.

### [Evaluation 1]

A liquid crystal panel (size: 500 mm×250 mm) was curved such that the color filter substrate had a convex surface on the viewing surface side, so that a first end (left end as viewed from the viewing surface side) and a second end (right end as viewed from the viewing surface side) in the longitudinal direction came close to each other on the thin-film transistor array substrate side (back surface side). In this state, the amount of misalignment of the color filter substrate with respect to the thin-film transistor array substrate was determined. Also, the amount of misalignment of the color filter substrate with respect to the thin-film transistor array substrate was calculated according to the following formula (T) to give a theoretical value.

“Amount of misalignment”=N×(t1+t2+d)/2R(T)

N: Distance from panel center in the longitudinal direction of liquid crystal panel

R: Curvature radius of liquid crystal panel in a curved state

t1: Thickness of color filter substrate

t2: Thickness of thin-film transistor array substrate

d: Thickness of liquid crystal layer

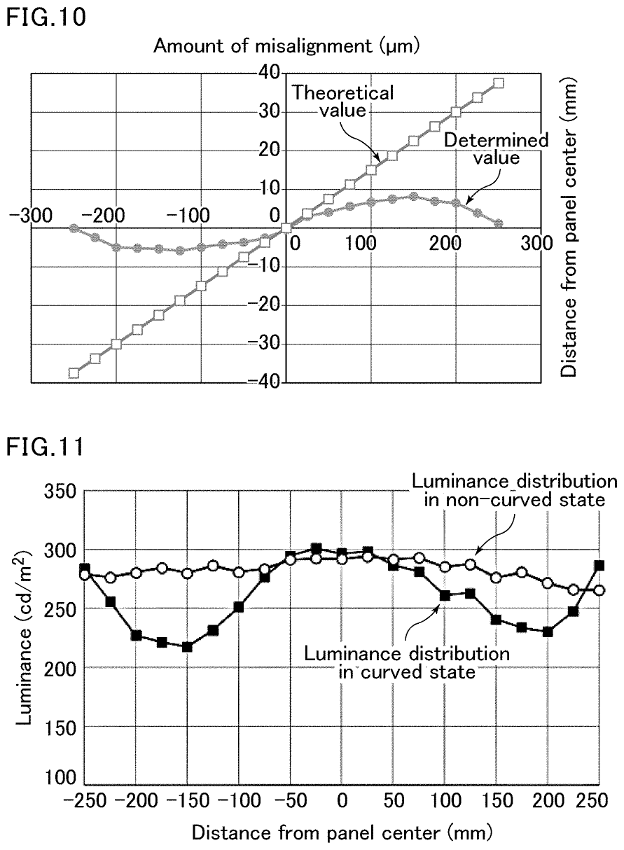

FIG. 10 is a graph showing the amount of misalignment of the color filter substrate with respect to the thin-film transistor array substrate in the liquid crystal panel in a curved state. The vertical axis in FIG. 10 represents the amount of misalignment of the color filter substrate with respect to the thin-film transistor array substrate (unit: μm), where the “+ direction” is defined as the direction the color filter substrate is shifted with respect to the thin-film transistor array substrate to the first end side of the liquid crystal panel and the “−direction” is defined as the direction the color filter substrate is shifted to the second end of the liquid crystal panel. The horizontal axis in FIG. 10 represents the distance from the panel center in the longitudinal direction of the liquid crystal panel (unit: mm), where the “+ direction” is defined as the direction from the panel center to the second end and the “− direction” is defined as the direction from the panel center to the first end side. The evaluation at each position (distance from panel center: N) in the longitudinal direction of the liquid crystal panel was performed under the conditions of R=1000 mm, t1=150 μm, t2=150 μm, and d=3 μm.

As shown in FIG. 10, the amount of misalignment of the color filter substrate with respect to the thin-film transistor array substrate was substantially symmetrical about the panel center in both the determined values and the theoretical values. Practically, the peripheries of the color filter substrate and the thin-film transistor array substrate are fixed with a sealing material. The color filter substrate is thus less likely to be shifted at the first end and the second end of the liquid crystal panel. As a result, the amount of misalignment tended to be smaller in the determined values than in the theoretical values. This tendency was similarly observed in the case of liquid crystal panels having different specifications (e.g., size, thickness) from those of the liquid crystal panel subjected to the present evaluation.

The results of the present evaluation show that excellent display quality is sufficiently achievable even in a curved state by enlarging the width of the black matrix in the direction as shown in FIG. 3 (Embodiment 1) by the maximum determined amount of misalignment as compared with the case in FIG. 12 (conventional case), for example. In other words, excellent display quality is sufficiently achievable even in a curved state by shifting the central axis P shown in FIG. 3 (Embodiment 1) from the central axis Q by the maximum determined amount of misalignment, for example.

### [Evaluation 2]

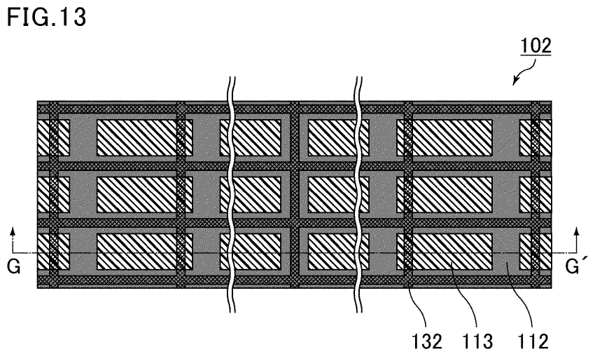

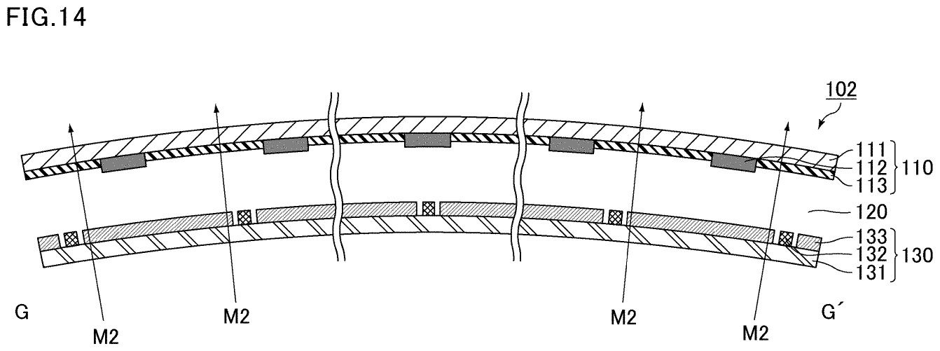

The conventional liquid crystal panel (size: 500 mm×250 mm) shown in FIG. 12 was curved such that the color filter substrate had a convex surface on the viewing surface side as shown in FIGS. 13 and 14, so that a first end (left end as viewed from the viewing surface side) and a second end (right end as viewed from the viewing surface side) in the longitudinal direction came close to each other on the thin-film transistor array substrate side (back surface side). In this state, the luminance of the liquid crystal display device was measured. The luminance of the liquid crystal display device was measured also in a non-curved state of the liquid crystal panel. The conditions such as the thicknesses of the members and the curvature radius when curving the liquid crystal panel were the same as in Evaluation 1.

FIG. 11 is a graph showing the luminances of the liquid crystal display device in a curved state and in a non-curved state of the liquid crystal panel. The vertical axis in FIG. 11 represents the luminance of the liquid crystal display device (unit: cd/m²). The horizontal axis in FIG. 11 represents the distance from the panel center in the longitudinal direction of the liquid crystal panel (unit: mm), where the “+ direction” is defined as the direction from the panel center to the second end and the “−direction” is defined as the direction from the panel center to the first end side.

In the conventional liquid crystal panel in a curved state, as shown in FIGS. 13 and 14, the position of the black matrix is shifted with respect to the conductive lines, whereby the regions with the conductive lines are shifted out of the region with the black matrix. As a result, in the liquid crystal panel in a curved state, the evenness of the aperture ratio distribution decreased to vary the luminances as shown in FIG. 11, as compared with that in the non-curved state. Practically, the peripheries of the color filter substrate and the thin-film transistor array substrate are fixed with a sealing material. The color filter substrate was thus less likely to be shifted at the first end and the second end of the liquid crystal panel. Accordingly, the luminance at each end was similar to the luminance at the panel center.

In contrast, in the present invention, the width of the black matrix is enlarged in consideration of the direction the position of the black matrix is shifted when curving a liquid crystal panel, and thus the evenness of the aperture ratio distribution is constant, which suppresses the variety of the luminances even in a curved state.

What is claimed is:

1. A liquid crystal panel comprising:
a color filter substrate including a black matrix;
a thin-film transistor array substrate including a conductive line; and
a liquid crystal layer held between the color filter substrate and the thin-film transistor array substrate,
the liquid crystal panel being capable of being curved such that a first end and a second end facing the first end come close to each other with respect to a standard axis extending in a first direction,
in a non-curved state of the liquid crystal panel, a region with the black matrix encompassing a region with the conductive line in a second direction that is perpendicular to the first direction, and
in the non-curved state of the liquid crystal panel, in the second direction, a first central axis located at a position halving a width of the black matrix and a second central axis located at a position halving a width of the conductive line satisfying a relation of:
(A) in a first end region between the first end and the standard axis, the first central axis is shifted closer to the first end than the second central axis is, and in a second end region between the second end and the standard axis, the first central axis is shifted closer to the second end than the second central axis is, or
(B) in the first end region between the first end and the standard axis, the first central axis is shifted closer to the standard axis than the second central axis is, and in the second end region between the second end and the standard axis, the first central axis is shifted closer to the standard axis than the second central axis is.

2. The liquid crystal panel according to claim 1,
wherein the standard axis is located at a position halving a width of the liquid crystal panel in the second direction.

3. The liquid crystal panel according to claim 1,
wherein the black matrix has a constant width in the second direction in a plane of the liquid crystal panel.

4. A liquid crystal display device comprising the liquid crystal panel according to claim 1 and a backlight.
